(19) United States
(12) Patent Application Publication
(10) Pub. No.: US 2004/0239100 A1
(43) Pub. Date: Dec. 2, 2004

(54) Surgical marking overlay and method of use

(76) Inventor: Ben M. Khalaj, San Clemente, CA (US)

Correspondence Address: BEN M. KHALAJ, 106 ARISTA, SAN CLEMENTE, CA, 92673, US

(21) Appl. No.: 10/452,337

(22) Filed: May 31, 2003

(51) Int. Cl. B42D 15/00

(52) U.S. Cl. 283/81; 128/850

(57) ABSTRACT

A set of surgical marking strips overlay and method of use is disclosed in this invention. These marking strips are pre-printed with desired surgical markings on one side preferably dashed lines, and on the other side can be bonded with adhesive that can be placed on the patient's skin where applicable for surgical procedure. Another way of overlay placement on patient's skin is to moistened area of skin to place marking overlay without any usage of bonded adhesive. At least one marking strip overlay with support sheet is placed into a sterilized pouch for usage prior to surgery. Marking strips can be individually packaged for a specific medical surgical procedure. The marking strips can peel-off easily when surgery is over without harming or disrupting the operated tissue. This feature is noticeable especially right after a cosmetic surgery such as soft tissue fixation procedure and facial aesthetic contouring or reconstruction.

### FIELD OF THE INVENTION

The present invention relates to surgical markings prior to surgical medical procedure in conjunction with surgical preparation for a patient. More particularly, this invention relates to a pre-printed surgical marking overlay, which can be used on soft or hard tissue on a mammal prior to surgical procedure.

### BACKGROUND OF THE INVENTION

Most surgeries require preliminary patient marking to indicate the type of surgery and its procedure for a patient. One of the surgical preparations is to draw surgical lines known as surgical marking. A Surgeon creates markings on patient's skin using marking pen devices to indicate the location and types of medical procedure to be done.

Surgical marking pens are disclosed in prior art inventions, such as U.S. Pat. No. 5,713,890 by Paul E. Chasan, entitled “Marking pen for coloring the skin”, and U.S. Pat. No. 6,197,034 by Gvozdic et al., entitled “Medical marking devices and method for their use”.

In spite of the advantages in prior art, there are some disadvantages and limitations that can not be delivered with respect to surgical marking techniques. One of the disadvantages of pen marking is to wipe off the surgical marks after surgery due to marking ink. Often marking ink need to be washed off by using washing detergent with some applied pressure force to wipe off the ink on skin or operated tissue, which results in unsatisfied shifting of soft tissue especially in cosmetic surgery of facial soft tissue fixation and suspension.

However, this invention overcomes the shortcomings of prior art devices and provides a unique peel off type surgical marking strip overlay to be used pre-operatively and intra-operatively on the epidermis of mammals without interfering with tissues to be operated on or around.

### SUMMARY OF THE INVENTION

It is an object of the present invention to provide a surgical marking overlay to be placed on the epidermis on or around surgical area such as soft or hard tissue prior to a medical procedure. This marking overlay is made of transparent strip which is pre-printed with the desired surgical marking on one side and the other side is bonded with adhesive or held by moistening the applicable skin area. A set of marking strips overlay is placed on a support sheet, and then placed into a sterilized or a non-sterilized pouch for usage before surgery.

It is further object of the present invention to provide a set of surgical marking strips overlay for face-lift surgery or facial aesthetic surgery or reconstruction. This set may contain overlay strips for eyebrows, cheeks, jaw lines and under chin. Furthermore, the marking overlay strips can be individually packaged for a specific medical procedure. It is yet another object of present invention to provide pre-shape marking strips overlay. The pre-shape overlays can be made into many different shapes such as straight dotted lines or in more complex arcs. These markings overlay can also be used as surgical guides for surgeons who perform the surgery or treatment regions and areas. It is yet still another object of present invention to provide a method of using these marking overlay by opening the pouch package and placing the marking strip over the soft or hard tissue of a patient where applicable. When the surgery is over, the marking strips can easily peel-off without harming or disrupting the operated tissue. This feature is noticeable especially after a cosmetic surgery such as soft tissue fixation procedure where any tissue manipulation is to be avoided.

Further objects and advantages of this invention will become apparent from consideration of the drawings and description that follows.

### BRIEF DESCRIPTION OF THE DRAWINGS

Exemplary embodiments of the invention will now be described in conjunction with the drawings in which:

FIG. 1 is a perspective view of the present invention showing different type of surgical marking overlay for face-lift surgery and facial aesthetic contouring or reconstruction.

FIG. 2 is a plan view of marking overlay shown in FIG. 1.

FIG. 3 is a plan view of marking overlay for a pair of eyebrow in face-lift surgery.

FIG. 4 is a plan view of marking overlay for a pair of cheek in face-lift surgery.

FIG. 5 is a plan view of marking overlay for a pair of jaw line in face-lift surgery.

FIG. 6 is a plan view of marking overlay for a pair of under chin in face-lift surgery.

FIG. 7 is a plan view of additional marking overlay for a pair of cheek in face-lift surgery.

### DETAILED DESCRIPTION OF THE INVENTION

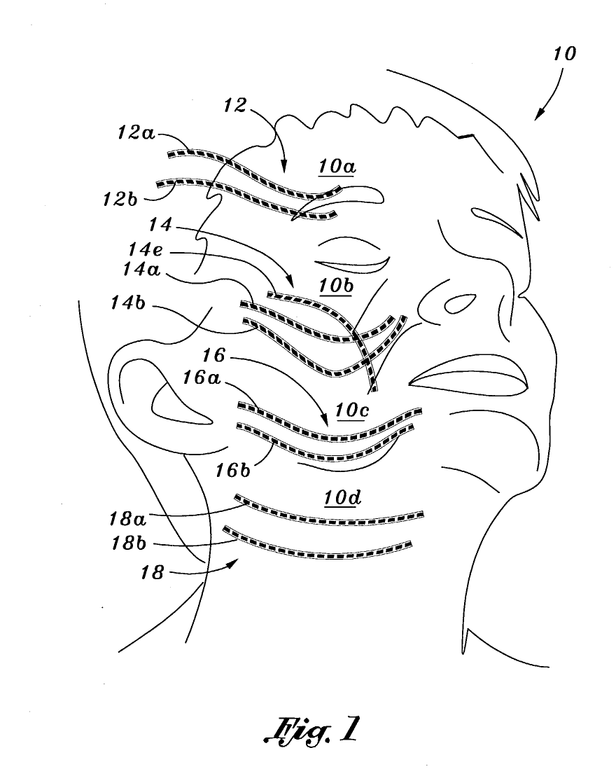

FIG. 1 illustrates a set of surgical marking strips overlay 12-16 placed on a patient's face 10 for purpose of face-life procedure. In this view marking strips are located on right side of a patient's face 10 and arrange in a pair in the area of eyebrow 10a, , cheek area 10b, jaw line 10c and under chin area 10d. These strips are placed on bonded side to the patient face on skin for purpose of surgical face-lift procedure such as soft tissue fixation procedure. The marking strip has pre-printed marking guide preferably in dashed lines on one side and on the other side bonded with adhesive. Marking strip is made of transparent material, which is pre-cut in desired shapes to be placed with on tissue area where applicable prior to surgery. Surgeons can also use these pre-printed strip overlay as a guide for desired medical procedures such as facelift. Other advantages of the marking overlay over the marking pen is peel off feature. When the surgery is over, the marking strips can peel-off easily without harming or disrupting the operated tissue. This feature is noticeable especially after a cosmetic surgery.

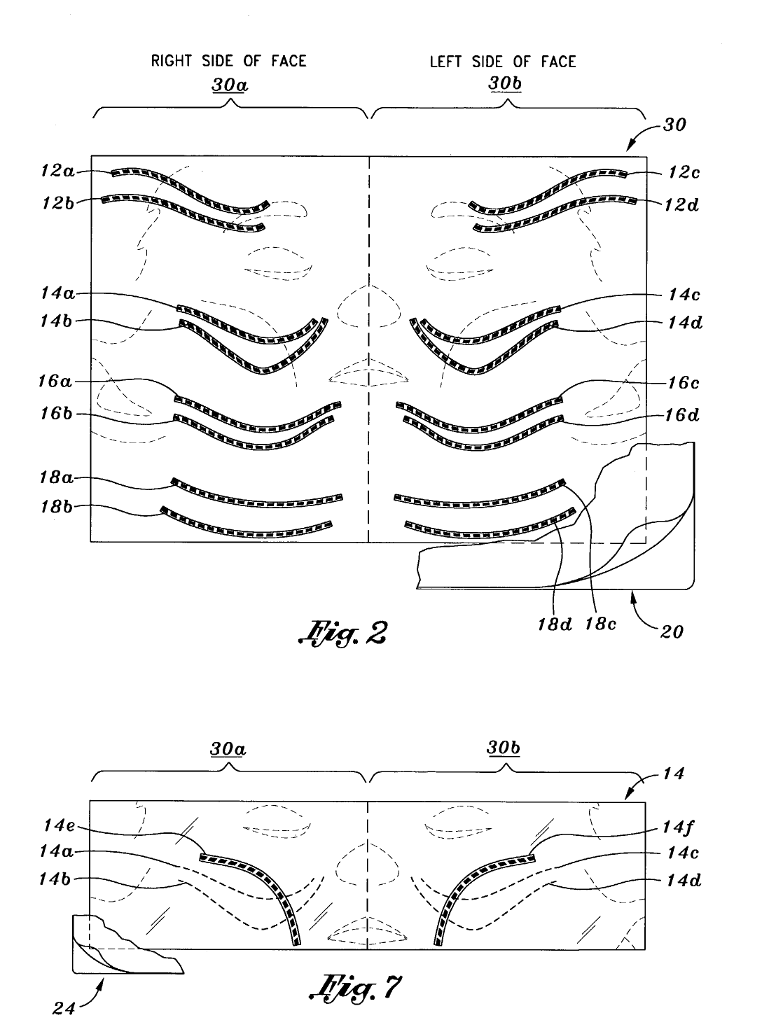

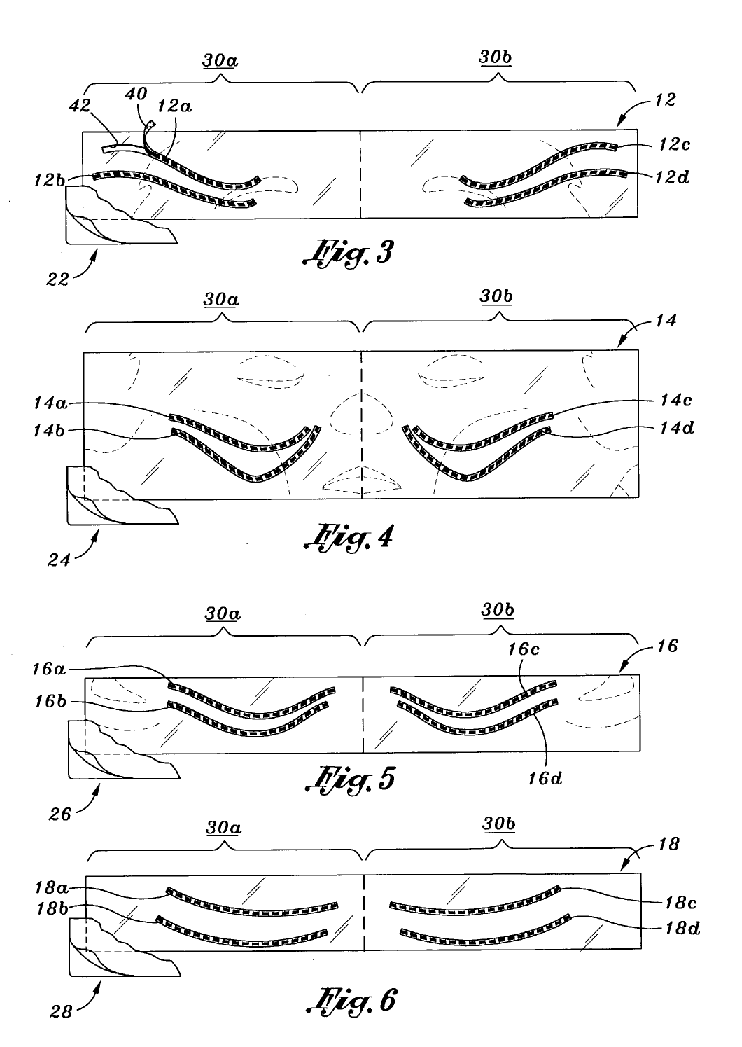

FIG. 2 showing sets of surgical marking strips overlay 30 in a template format for facelift surgery and facial aesthetic contouring or reconstructions. The marking strips are packaged as a set in a preferred sterilized pouch 20 that contains marking strips for right side 30a and left side 30b of the patient face 10. Both right side and left side of this template contains a pair of strips for eyebrows 12a- 12d, cheeks marking strips 14a-14d, jaw lines marking strips 16a-16d and under chin marking strips 18a-18b. Each marking strip has pre-printed graphics on top and bonded adhesive on the bottom 40. Marking strip is precut 42 in the sheet for purpose of lifting strip and applying on the face. Surgical marking overlay also can be package in pouches 22, 24, 26 and 28 in a pair for specific surgical procedures as seen in FIG. 3 thru FIG. 6.

FIG. 7 also is illustrating additional marking strips 14e, 14f on cheek area 10b that shows marking strips can be shaped in upward arc for specific cheek tissue to be lifted.

While this invention is susceptible of embodiments in many different forms, this specification and the accompanying drawings disclose only some specific forms as examples of the invention. The invention is not intended to be limited to the embodiments so described. However, the scope of the invention is pointed out in the appended claims.

We claim:

1. A surgical marking overlay comprising:
at least one marking strip, said marking strip has pre-printed markings on one side and on the other side is bonded with adhesive, said marking strip is made in desired pre-cut shaped to be placed on skin area where applicable prior to surgery, said marking strip can be easily peel off after surgery, and;
a support sheet, said sheet has non-stickable surface on one side and it is used to place at least one said marking strip on said non-stickable surface of said support sheet.

2. A surgical marking overlay according to claim 1, wherein said marking strip made of a transparent material.

3. A surgical marking overlay according to claim 1, wherein said marking strip has preprinted markings can be graphics line.

4. A surgical marking overlay according to claim 1, wherein said marking strip is made in desired pre-cut shape, can be shaped in straight line.

5. A surgical marking overlay according to claim 1, wherein said marking strip is made in desired pre-cut shape, can be shaped in non-straight shapes.

6. A surgical marking overlay comprising:
at least one marking strip, said marking strip has pre-printed markings on one side and on the other side is bonded with adhesive, said marking strip is made in desired pre-cut shaped to be placed on skin area where applicable prior to surgery, said marking strip can be easily peel off after surgery;
a support sheet, said sheet has non-stickable surface on one side and it is used to place at least one said marking strip on said non-stickable surface of said support sheet, and;
a pouch, said pouch accommodate said marking strip and said support sheet into said pouch.

7. A surgical marking overlay according to claim 1, wherein said pouch is sterilized.

8. A surgical marking overlay according to claim 1, wherein said pouch is non-sterilized.

9. A surgical marking overlay comprising:
at least one marking strip, said marking strip has pre-printed markings on one side and on the other side is plain, said marking strip is made in desired pre-cut shaped to be placed on moistened skin area where applicable prior to surgery , said marking strip can be easily peel off after surgery;
a support sheet, said sheet has non-stickable surface on one side and it is used to place at least one said marking strip on said non-stickable surface of said support sheet.
